(19) United States
(12) Patent Application Publication
(10) Pub. No.: US 2017/0193514 A1
(43) Pub. Date: Jul. 6, 2017

(54) Method for Performing Machine Detection of a Suspicious Transaction

(71) Applicant: E. Sun Commercial Bank, Ltd., Taipei City (TW)

(72) Inventor: Hung-Yao Chen, Taipei City (TW)

(21) Appl. No.: 15/393,320

(22) Filed: Dec. 29, 2016

(30) Foreign Application Priority Data
Dec. 31, 2015 (TW) 104144745

(51) Int. Cl. G06Q 20/40; G06Q 20/10

(52) U.S. Cl. CPC G06Q 20/4016; G06Q 20/108

(57) ABSTRACT

A method for detection of a suspicious transaction includes: retrieving a data set of client data associated with a client account and a client; assigning respective risk values to items of the data set of client data; calculating a weighted score based on the risk values and a weight list; assigning a risk level to the client based on the weighted score; retrieving transaction details of the client account for calculating a transaction parameter set; and when it is determined that the client account is involved in at least one transaction, determining whether the transaction is a suspicious transaction based on the risk level, the transaction parameter set and a pre-stored rule set.

### CROSS-REFERENCE TO RELATED APPLICATION

This application claims priority of Taiwanese Patent Application No. 104144745, filed on Dec. 31, 2015.

### FIELD

The disclosure relates to a method for performing machine detection of a suspicious transaction on at least one client account that is associated with a client.

### BACKGROUND

Typically, for a money services business (MSB), a considerable amount of transaction activities (e.g., transfer, deposit, withdrawal and conversion) may be processed in any business day. It is then desirable for a financial institution to monitor the transaction activities in order to identify one or more suspicious transactions, which may be actions of money laundering conducted in an attempt to be buried in the sea of transaction activities and remain undetected.

It is known that suspicious transactions may be conducted using dummy accounts with fake identifications and/or shell corporations.

As a result, in order to achieve the desired effect of anti-money laundering (AML), most countries have provided regulations for financial institutions to monitor the transactions. For example, Taiwanese government provides regulations regarding AML for reference by both banks and securities brokers. Under such regulations, a client may be required to present his/her identification for allowing process of domestic transfers. Note that the regulations regarding AML may vary from time to time, and from country to country.

It is noted that due to the large amount of transactions being processed, higher efficiency and accuracy may be desired for simultaneously monitoring as much transaction activities as possible.

### SUMMARY

One object of the disclosure is to provide a method for detecting a suspicious transaction with a high efficiency and accuracy, and allows for simple adjustments for accommodating changes of regulations regarding anti-money laundering.

According to one embodiment of the disclosure, the method is for performing machine detection of a suspicious transaction on at least one client account that is associated with a client. The method may be implemented by a system that includes a client database, a rule database, a data management server and an assessment server. The data management server stores data regarding the client account. The method includes the steps of:

a) retrieving, by the data management server, a data set of client data from the client database, the data set of client data being associated with the client account and the client, and including a number of items respectively directed to a number of risk factors;

b) transmitting, by the data management server, the data set of client data to the assessment server;

c) assigning, by the assessment server, respective risk values to the items of the data set of client data based on a risk-value lookup table that is pre-stored in the rule database;

d) transmitting, by the assessment server, the risk values to the data management server;

e) calculating, by the data management server, a weighted score based on the risk values and a weight list that is pre-stored in the client database and that is associated with the risk factors;

f) assigning, by the data management server, a risk level to the client based on the weighted score;

g) retrieving, by the data management server, from the client database transaction details associated with the client account within a predetermined previous period that is immediately prior to a current business day, the transaction details including information associated with at least one transaction that has occurred on the client account;

h) calculating, by the data management server, a transaction parameter set based on the transaction details;

i) transmitting, by the data management server, the risk level and the transaction parameter set to the assessment server;

j) determining, by the assessment server, whether the client account is involved in at least one transaction during a predetermined detecting period that includes the current business day and at least one previous business day immediately prior to the current business day; and

k) when the determination of step j) is affirmative, determining, by the assessment server, whether the transaction is a suspicious transaction based on the risk level, the transaction parameter set and a rule set pre-stored in the rule database.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a system according to one embodiment of the disclosure;

FIG. 2 is a flow chart illustrating steps of a method for performing machine detection of a suspicious transaction on at least one client account, according to one embodiment of the disclosure; and

FIG. 3 is a flow chart illustrating sub-steps performed by a data management server for calculating a weighted score.

### DETAILED DESCRIPTION

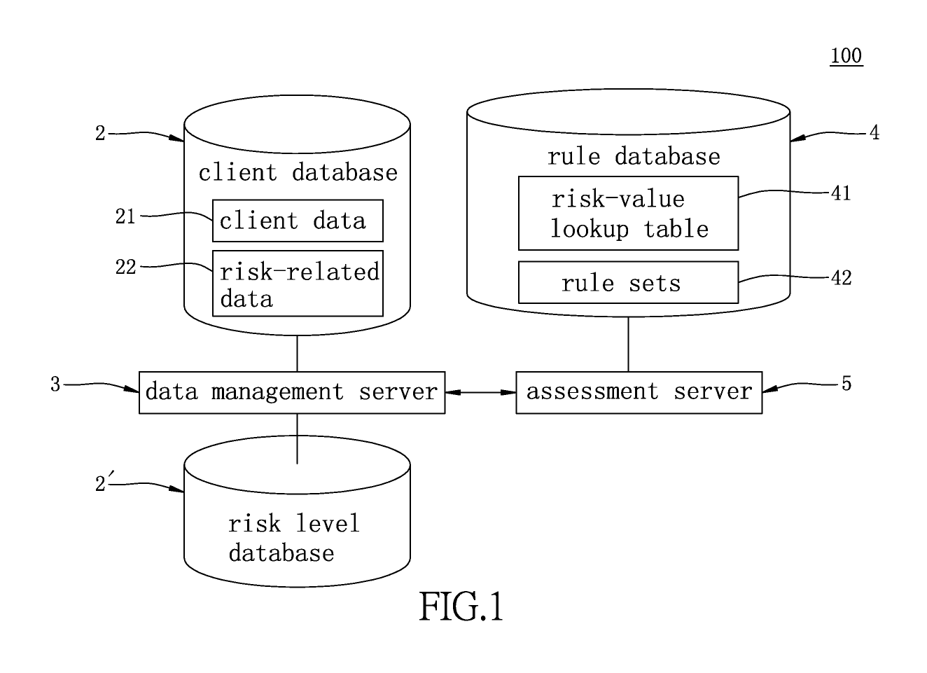

FIG. 1 is a block diagram illustrating a system 100 according to one embodiment of the disclosure.

The system 100 includes a client database 2, a data management server 3, a rule database 4 and an assessment server 5. The system 100 is capable of performing machine detection of a suspicious transaction on at least one client account that is associated with a client.

The client database 2 stores therein client data 21 associated with a number of clients, and risk-related data 22. The client data 21 includes a number of data sets each associated with a respective one of the clients. Each of the data sets includes basic information regarding the respective client, account information regarding any client account that is associated with the respective client, and transaction details regarding all transactions involving the client account(s) associated with the respective client. In particular, each data set has a number of items, each directed to a corresponding one of risk factors. The items may constitute part or one or more of the basic information, the account information and the transaction details. The transaction details may include information on transactions processed within a predetermined time period, including a current business day.

The risk-related data 22 includes a risk-related data list that includes item options for each of the risk factors. Each item in each data set is one of the item options corresponding to the respective risk factor.

Specifically, in this embodiment, the risk factors are categorized into one or more of a client-related category, an account-related category and a geographical category.

The client-related category includes, but is not limited to, risk factors of a client type, a client identification type or a client occupation type. The account-related category includes, but is not limited to, risk factors of an account type, a manner in which the client account is opened, a source of fund used to open the client account, a service that is associated with the client account, or an activity frequency of the client account. The geographical category includes, but is not limited to, risk factors of an address of the client, or a location (e.g., country or region) in which a finical activity has occurred on the client account.

The following Table 1 includes exemplary information that may be used to further describe the item options included in the risk-related data list.

TABLE 1

| Category | Risk Factor | Item Options |
|---|---|---|
| Client-related | Client type | Natural person; Juridical person |
| category | | (Medium/Large (M/L)); |
| | | Juridical person (Medium/Small |
| | | (M/S)); Juridical person (Global |
| | | Finance); Juridical person(SB) |
| | Client identification | ID Card; Business Registration |
| | type | Certificate; Residence Permit; |
| | | Passport; Offshore Banking Unit |
| | | (OBU) ID number |
| | Client occupation | Distinct codes associated with |
| | type | the occupation of the client, as |
| | | announced by the Directorate |
| | | General of Budget, Accounting |
| | | and Statistics (DGBAS) |
| Account-related | Account type | Time deposit; Composite |
| category | | deposit; Checking deposit; Gold |
| | | account; Foreign Exchange |
| | | (FOREX) time deposit; FOREX |
| | | composite deposit; FOREX |
| | | checking deposit; |
| | Account open | At-the-Counter; Online |
| | manner | |
| | Source of fund | Cash; Check; Transfer; |
| | | Domestic remittance; Foreign |
| | | remittance |
| | Service associated | Loan |
| | Activity frequency | Dormant; Active |
| Geographical | Address of the | Names of possible |
| category | client | countries/regions in which the |
| | | address may be located |
| | Location of activity | Names of possible |
| | | countries/regions in which a |
| | | financial activity may occur on |
| | | an account |

For example, in Taiwan, a juridical person is categorized as medium/large (M/L) when an annual revenue thereof is larger than 1 billion NTD, as medium/small (M/S) when the annual revenue thereof is between 30 million and 1 billion NTD, and as SB when the annual revenue thereof is less than 30 million NTD. A juridical person that operates across Taiwan, Hong Kong and China with an offshore banking unit (OBU) is categorized as a Global Finance.

Based on the activity frequency of the client account, the client account may be categorized as a dormant account when the transaction details indicate that the client account is involved in no more than one transaction during a given period (e.g., 6 months) that precedes a predetermined detecting period (e.g., three consecutive business days including the current business day). On the other hand, when the client account is involved in more than one transaction during the 6-month period, the client account may be categorized as an active account.

The risk-related data 22 further includes a weight list having a number of factor weights corresponding respectively with the risk factors, and three category weights corresponding respectively with the client-related category, the account-related category and the geographical category.

The following Table 2 includes exemplary factor weights and category weights that may be used to define a risk level associated with a client.

TABLE 2

| | Category Weight | | Factor Weight |
|---|---|---|---|
| Category | (%) | Risk Factor | (%) |
| Client-related | 30 | Client type | 30 |
| category | | Client | 30 |
| | | identification type | |
| | | Client occupation | 40 |
| | | type | |
| Account-related | 35 | Account type | 25 |
| category | | Account open | 5 |
| | | manner | |
| | | Source of fund | 5 |
| | | Service associated | 40 |
| | | Activity | 25 |
| | | frequency | |
| Geographical | 35 | Address of the | 10 |
| category | | client | |
| | | Location of | 90 |
| | | activity | |

The rule database 4 stores therein a risk-value lookup table 41 and a number of rule sets 42.

The risk-value lookup table 41 includes a number of risk values assigned respectively to the item options of the risk-related data list.

The following Tables 3A to 3C each include exemplary risk values assigned to the item options of the risk-related data list, for a respective one of the client-related category, the account-related category and the geographical category.

TABLE 3A
(client-related category)

| Risk Factor | Item Option(s) | Risk Value |
|---|---|---|
| Client type | Natural person or Juridical person | 100 |
| Client | ID Card | 40 |
| identification | Business Registration Certificate | 100 |
| type | Residence Permit, Passport, OBU ID | 140 |
| | number | |
| Client | Public Sector, Education, Water & Gas, | 40 |
| occupation/ | Wholesale & Retail, Accommodation & | |
| Occupational | Catering Services, Transport, Storage & | |
| type | Communication, Finance & Insurance, Real | |
| | Estate & Leasing, Professional Services, | |
| | Technical Services/ | |
| | Agriculture, Forestry, Fishery, Animal | |
| | Husbandry, Manufacturing, Spinning, | |
| | Weaving, Transportation, Warehousing, | |
| | Publishing, Television Broadcasting and Pay | |
| | Broadcasting, Telecommunications, | |
| | Services, Financial Institutions, Insurance, | |
| | Securities, Futures, Market Research and | |
| | Opinion Polls, Leasing, Personal and | |
| | Household Maintenance | |
| | Manufacturing, Wholesale and Retail Trade, | 100 |
| | Accommodation and Catering,/ | |
| | Construction, Civil Engineering, | |
| | Construction Industry, Commodity | |
| | Brokerage, Watches and Eyewear | |
| | Wholesale, Watches and Eyewear Retail, | |
| | Building Materials Wholesale, Building | |
| | Materials Retail, Secondhand Commodity | |
| | Retailing, Fuel Retailing, Direct Selling, | |
| | Catering, Financial Assistance, Real Estate, | |
| | Corporation Management Agencies, Private | |
| | Detective Services, Laundry, Hairdressing, | |
| | Beauty Industry, Funeral Services | |
| | Industrial and Commercial Services, | 140 |
| | Agriculture, Forestry, Fisheries and Animal | |
| | Husbandry, Ore, Earth and Stone Mining | |
| | Industry, Construction Industry/ | |
| | Waste Removal, Treatment and Recycling, | |
| | Pollution Remediation, Jewelry and | |
| | Precious Metal Production, Jewelry & | |
| | Precious Metal Products Wholesale, Jewelry | |
| | & Precious Metals Retail, Real Estate | |
| | Brokerage, Legal & Accounting Services, | |
| | Management Consultancy, Gaming | |
| | Industry, Ballroom, Electronic Arcade | |
| | Industry, Pawnbroking, Private Financing | |

TABLE 3B
(account-related category)

| Risk Factor | Item Option(s) | Risk Value |
|---|---|---|
| Account type | Time deposit; Composite deposit; FOREX | 40 |
| | time deposit; FOREX composite deposit | |
| | Checking deposit; Gold account; FOREX | 100 |
| | checking deposit | |
| Account | At-the-Counter | 40 |
| open manner | Online | 140 |
| Source of | Cash; Check | 40 |
| fund | Domestic remittance | 100 |
| | Foreign remittance; Transfer | 140 |
| Service | Loan; Deposit | 40 |
| associated | | |
| Activity | Dormant | 200 |
| frequency | Active | 40 |

TABLE 3C
(geographical category)

| Risk Factor | Item Option(s) | Risk Value |
|---|---|---|
| Address of | Aland Islands, American Samoa Andorra, | 40 |
| the client/ | British Anguilla, Antarctica, Antigua and | |
| Locations of | Barbuda, Argentina, Armenia, Aruba, | |
| activity | Australia, Austria, Azerbaijan, Bahamas, | |
| | Bahrain, Bangladesh, Barbados, Belarus, | |
| | Belgium, Belize, Benin (Dahomey), | |
| | Bermuda, Bhutan, Bolivia, Bonaire, Sint | |
| | Eustatius and Saba, Bosnia and | |
| | Herzegovina, Botswana, Bouvet Island, | |
| | Brazil, British Indian Ocean Territory, | |
| | Brunei, Bulgaria, Ethiopia, Faroe Islands, | |
| | Falkland Islands, Fiji, Finland, France, | |
| | French Guiana, French Polynesia, French | |
| | Southern Territories, Gabon, Gambia, | |
| | Georgia, Germany, Ghana, Gibraltar, | |
| | Greece, Greenland, Grenada, Guadeloupe | |
| | Island, Guam, Guatemala, Guernsey, | |
| | Guinea, Guinea-Bissau, Guyana, Haiti, | |
| | Heard and McDonald Islands, Holy See, | |
| | Honduras, Hong Kong, Hungary, Iceland, | |
| | India, Mauritania, Mauritius, Mayotte, | |
| | Mexico, Micronesia, Moldova, Monaco, | |
| | Mongolia, Montenegro, Montserrat, | |
| | Morocco, Mozambique, Nauru, Nepal, the | |
| | Netherlands, New Caledonia, New | |
| | Zealand, Niger, Nigeria, Niue, Norfolk | |
| | Islands, Northern Mariana Islands, | |
| | Norway, Oman, Palau, Panama Canal | |
| | Zone, Paraguay, South Georgia and the | |
| | South Sandwich Islands, South Sudan, | |
| | Spain, Sri Lanka, Suriname, Svalbard and | |
| | Jan Mayen Islands, Swaziland, Sweden, | |
| | Switzerland, Taiwan, Taiwan (OBU), | |
| | Tajikistan, Tanzania, Thailand, East | |
| | Timor, Togo, Tokelau, Tonga, Trinidad | |
| | and Tobago, Tunisia, Turkey, | |
| | Turkmenistan, Turks and Caicos Islands, | |
| | Tuvalu, Uganda, Ukraine, Republic of | |
| | Upper Volta (Burkina Faso), Burundi, | |
| | Cameroon, Canada, Cape Verde and the | |
| | Cayman Islands, Central African Republic, | |
| | Chad, Chile, mainland China, Christmas | |
| | Island, Cocos Islands, Colombia, | |
| | Comoros, Congo (Zaire), Cook Islands, | |
| | Costa Rica, Ivory Coast, Croatia, Cuba, | |
| | Curacao, Cyprus, the Czech Republic, | |
| | Denmark, Djibouti, Dominica, Dominican | |
| | Republic, Egypt, El Salvador, Equatorial | |
| | Guinea, Eritrea, Estonia, Iraq, Ireland, | |
| | Isle of Man, Israel, Italy, Jamaica, Japan, | |
| | Jersey, Jordan, Kazakhstan, Kenya, | |
| | Kiribati, Republic of Korea, Kyrgyzstan, | |
| | Latvia, Lebanon, Lesotho, Liberia, Libya, | |
| | Liechtenstein, Lithuania, Luxembourg, | |
| | Macau, Macedonia, Madagascar, Malawi, | |
| | Malaysia, Maldives, Mali, Malta, Marshall | |
| | Islands, French Martinique, Peru, | |
| | Philippines, Pitcairn Island, Poland, | |
| | Portugal, Puerto Rico, Qatar, Réunion, | |
| | Romania, the Russian Federation, Rwanda, | |
| | Saint Barthélemy, St. Helena, Saint Kitts | |
| | and Nevis, St. Lucia, St. Martin (French), | |
| | Saint Pierre and Miquelon Islands, Saint | |
| | Vincent and the Grenadines, Samoan | |
| | Islands, San Marino, Sao Tome and | |
| | Principe, Saudi Arabia, Senegal, Serbia, | |
| | Seychelles, Sierra Leone, Singapore, St. | |
| | Martin (Netherlands), Slovakia, Slovenia, | |
| | Solomon Islands, Somalia, Republic of | |
| | South Africa, United Arab Emirates, | |
| | United Kingdom, United States, United | |
| | States Minor Outlying Islands, Uruguay, | |
| | Uzbekistan, Vanuatu, Venezuela, Vietnam, | |
| | British Virgin Islands, United States | |
| | Virgin Islands, Wallis and Futuna, | |
| | Western Sahara, Zambia, Automated | |
| | Teller Machine (ATM) cash withdraw*, | |
| | International airport settlement* | |
| | Afghanistan, Albania, Angola, Namibia, | 100 |
| | Nicaragua, Pakistan, Panama, Papua New | |
| | Guinea, Sudan, Syria, Khmer, Kuwait, | |
| | Laos, North Yemen, Zimbabwe (Rhodesia) | |
| | Algeria, Indonesia, Myanmar, Ecuador | 140 |
| | Iran, North Korea | 200 |

*only applies to location of activity

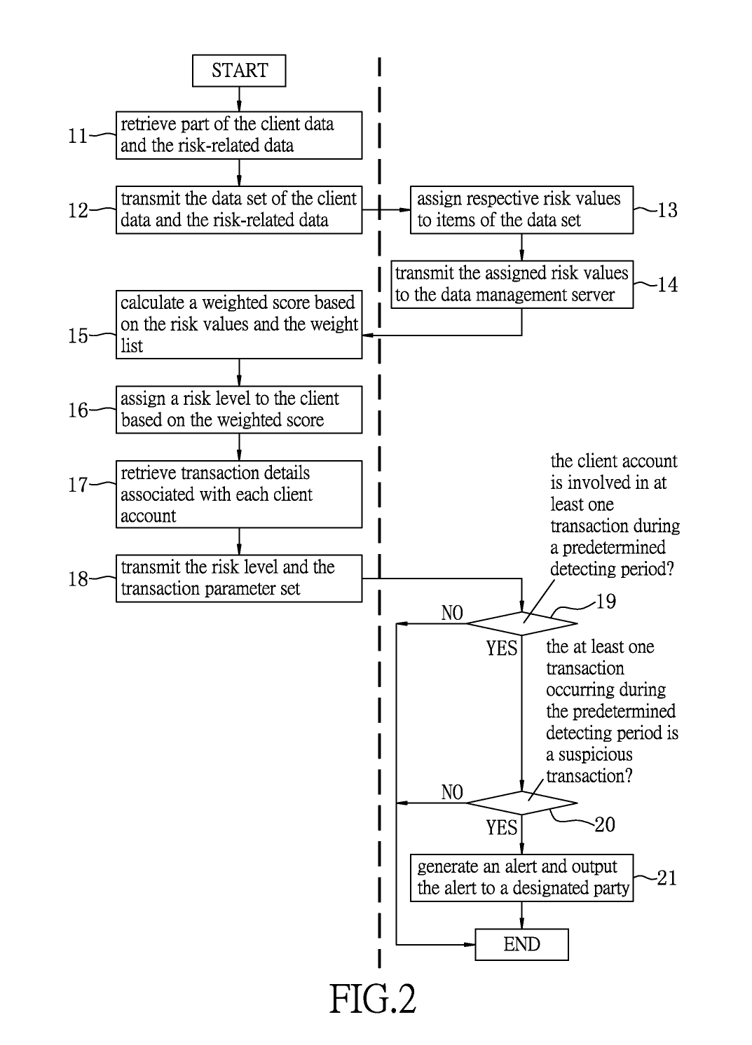

FIG. 2 is a flow chart illustrating steps of a method for performing machine detection of a suspicious transaction on at least one client account that is associated with a client. The method may be implemented by the system 100 as depicted in FIG. 1.

It is noted that each of the data management server 3 and the assessment server 5 includes a processor for executing instructions of an application program in order to implement corresponding steps of the method, and includes a communication component for supporting wired and/or wireless communication with each other.

In step 11, the data management server 3 retrieves part of the client data 21 and the risk-related data 22 from the client database 2. Specifically, aside from the risk-related data 22, the data management server 3 retrieves the data set of the client data 21 that corresponds to the client.

Afterward, in step 12, the data management server 3 transmits the data set of the client data 21 and the risk-related data 22 to the assessment server 5.

In response to receipt of the data set of the client data 21 and the risk-related data 22, in step 13, the assessment server 5 assigns respective risk values to the items of the data set associated with the client, based on the risk-related data list and the weight list included in the risk-related data 22 and the risk-value lookup table 41 pre-stored in the rule database 4.

The following Table 4 includes an exemplary part of the data set associated with a particular client, and the corresponding assigned risk values based on the risk-value lookup table 41 as exemplified by Table 3.

TABLE 4

| | | | Risk |
|---|---|---|---|
| | | | Value |
| Category | Risk Factor | Item in the data set | assigned |
| Client-related | Client type | Natural person | 100 |
| category | Client | ID Card | 40 |
| | identification | | |
| | type | | |
| | Client | Financial assistance | 100 |
| | occupation/ | | |
| | Occupational | | |
| | type | | |
| Account-related | Account type | Time deposit | 40 |
| category | Account open | Online | 140 |
| | manner | | |
| | Source of fund | Transfer | 140 |
| | Service | Deposit | 40 |
| | associated | | |
| | Activity | Active | 40 |
| | frequency | | |
| Geographical | Address of the | Taiwan | 40 |
| category | client/ | Taiwan | 40 |
| | Countries of | | |
| | activity | | |

In step 14, the assessment server 5 transmits the assigned risk values to the data management server 3.

In step 15, the data management server 3 calculates a weighted score based on the risk values and the weight list (see Table 2).

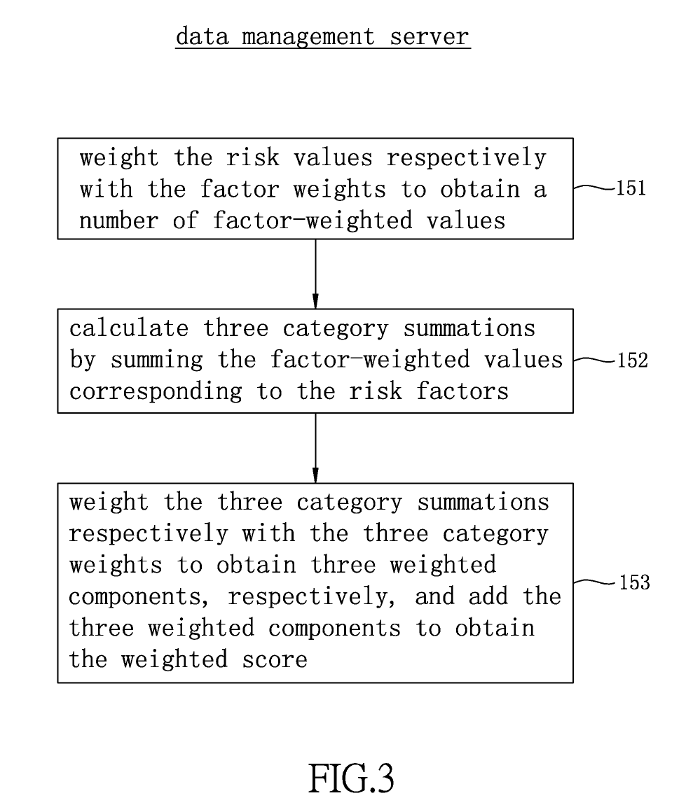

Specifically, FIG. 3 is a flow chart illustrating sub-steps performed by the data management server 3 for calculating the weighted score. The sub-steps may be implemented by the data management server 3 executing an application program.

In sub-step 151, in response to receipt of the risk values, the data management server 3 weights the risk values respectively with the factor weights to obtain a number of factor-weighted values, respectively.

The following Tables 5A to 5C illustrate exemplary factor-weighted values, taking the factor weights set in Table 2 and the risk values assigned in Table 4 as an example.

TABLE 5A
(client-related category)

| | | | Factor | |
|---|---|---|---|---|
| | | Risk | Weight | Factor-weighted |
| Risk Factor | Information | Value | (%) | values |
| Client type | Natural | 100 | 30 | 30 |
| | person | | | |
| Client | ID Card | 40 | 30 | 12 |
| identification | | | | |
| type | | | | |
| Client | Financial | 100 | 40 | 40 |
| occupation/ | assistance | | | |
| Occupational | | | | |
| type | | | | |

TABLE 5B
(account-related category)

| | | | Factor | |
|---|---|---|---|---|
| | | Risk | Weight | Factor-weighted |
| Risk Factor | Information | Value | (%) | values |
| Account type | Time deposit | 40 | 25 | 10 |
| Account | Online | 140 | 5 | 7 |
| open manner | | | | |
| Source of | Transfer | 140 | 5 | 7 |
| fund | | | | |
| Service | Deposit | 40 | 25 | 10 |
| associated | | | | |
| Activity | Active | 40 | 40 | 16 |
| frequency | | | | |

TABLE 5C
(geographical category)

| | | | Factor | |
|---|---|---|---|---|
| | | Risk | Weight | Factor-weighted |
| Risk Factor | Information | Value | (%) | values |
| Address of | Taiwan | 40 | 10 | 4 |
| the client/ | Taiwan | 40 | 90 | 36 |
| Location of | | | | |
| activity | | | | |

In sub-step 152, the data management server 3 calculates three category summations by summing the factor-weighted values corresponding to the risk factor(s) categorized in a respective one of the client-related category, the account-related category and the geographical category in order to obtain each category summation.

Taking the data included in Tables 5A to 5C as an example, the three category summations may be calculated as 82 (30+12+40), 50 (10+7+7+10+16), and 40 (4+36), respectively.

In sub-step 153, the data management server 3 weights the three category summations respectively with the three category weights to obtain three weighted components, respectively. Afterward, the data management server 3 adds the three weighted components to obtain the weighted score.

The following Table 6 includes the three weighted components and the weighted score using the data from Tables 2 and 5A to 5C.

TABLE 6

| | Category | Category | Weighted | Weighted |
|---|---|---|---|---|
| Category | summations | Weight (%) | component | score |
| Client-related | 82 | 30 | 24.6 | 56.1 |
| Account-related | 50 | 35 | 17.5 | |
| Geographical | 40 | 35 | 14 | |

In step 16, the data management server 3 assigns a risk level to the client based on the weighted score. In particular, the data management server 3 assigns a high risk level when the weighted score is above a first threshold, assigns a medium risk level when the weighted score is between the first threshold and a second threshold that is smaller than the first threshold, and assigns a low risk level when the weighted score is below the second threshold. In this embodiment, the first threshold is 80 and the second threshold is 60. As a result, the client whose weight score is 56.1 as shown in Table 6 is assigned the low risk level.

In one embodiment, the risk level assigned may be separately stored in a risk level database 2′ that is coupled to or accessible by the data management server 3 (see FIG. 1).

In step 17, the data management server 3 retrieves, from the client database 2, transaction details associated with each client account corresponding to the client within a predetermined previous period that is immediately prior to the current business day. The transaction details include information associated with transactions that have occurred on the client account. In this embodiment, the predetermined previous period is set at three months.

Afterwards, the data management server 3 calculates a transaction parameter set based on the transaction details for each client account. In this embodiment, the transaction parameter set includes an average dollar amount (can be any currency as desired) of multiple transactions within the predetermined previous period, and a standard deviation associated with the dollar amounts of the transactions within the predetermined previous period.

In step 18, the data management server 3 transmits the risk level and the transaction parameter set to the assessment server 5.

In step 19, the assessment server 5 determines whether the client account is involved in at least one transaction during a predetermined detecting period. Specifically, the predetermined detecting period includes the current business day and a number (N) of previous business days immediately prior to the current business day. When the determination is affirmative, the flow proceeds to step 20. Otherwise, the method is terminated.

In step 20, the assessment server 5 determines whether each transaction occurring during the predetermined detecting period is a suspicious transaction. The determination may be made based on the risk level associated with the client (as assigned in step 16), the transaction parameter set and the rule sets 42 pre-stored in the rule database 4.

A number of examples regarding the implementation of step 20 using various rule sets 42 (first to sixth rule sets) will now be described in the following paragraphs.

In a first example, the first rule set includes a daily transaction threshold (i.e., a threshold set for the number of transactions within one business day), and a daily dollar amount threshold for a client type and the risk level of the client (i.e., a threshold set for the total dollar amount involved in the transaction(s) within one business day).

With such a rule set, in step 20, when a number of transactions involving the client account within the current business day is no smaller than the daily transaction threshold, and when at least one of a total cash withdrawal amount from the client account and a total cash deposit amount into the client account within the current business day exceeds the daily dollar amount threshold, any cash withdrawal/deposit transaction that contributes to the at least one of the total cash withdrawal amount and the total cash deposit amount is determined as a suspicious transaction.

In this example, the daily transaction threshold and/or the daily dollar amount threshold may be set differently for different clients. The following Table 7 lists exemplary daily dollar amount thresholds set based on the client type and the risk level.

TABLE 7

| | Daily dollar amount threshold | | | Daily |
|---|---|---|---|---|
| | (unit: 10K NTD) | | | transaction |
| | High | Medium | Low | threshold |
| | Risk | Risk | Risk | (number of |
| Client type | Level | Level | Level | times) |
| Natural | 50 | 80 | 90 | 2 |
| person | | | | |
| Juridical | 100 | 100 | 100 | 2 |
| person | | | | |

When it is detected that a client account, which is associated with a natural person assigned a high risk level, receives three cash deposit transactions of 100,000, 300,000 and 180,000 NTD, respectively, the assessment server 5 determines that the a number of transactions (i.e., 3) exceeds the daily transaction threshold (i.e., 2), and the total cash deposit amount into the client account within the current business day (580,000) exceeds the daily dollar amount threshold (500,000). As such, all three cash deposit transactions are determined to be suspicious transactions.

It is noted that the first rule set is created to detect withdrawal or deposit activities in the client account that is deemed abnormal based on the risk factors of the client.

In a second example, the second rule set includes a daily transaction threshold (i.e., a threshold set for the number of transactions within one business day), and a dollar amount threshold for the client type and the risk level of the client (i.e., a threshold set for the dollar amount involved in an individual transaction).

With such a rule set, in step 20, a transaction occurring in the current business day having an amount larger than the dollar amount threshold is defined as an abnormal transaction. When a number of abnormal transactions each having an amount larger than the dollar amount threshold is no smaller than the daily transaction threshold, the abnormal transactions are determined as suspicious transactions.

In this example, the dollar amount threshold may be calculated by

T_{d}=Avg+(Stdev*M)

where T_{d} represents dollar amount threshold, Avg represents the average dollar amount, Stdev represents the standard deviation, and M represents a multiplier associated with the risk level of the client.

The following Table 8 lists exemplary multipliers and daily transaction thresholds set based on clients with different risk levels.

TABLE 8

| | Multiplier | | | Daily transaction threshold | | |
|---|---|---|---|---|---|---|
| | High | Medium | Low | High | Medium | Low |
| Client | Risk | Risk | Risk | Risk | Risk | Risk |
| type | Level | Level | Level | Level | Level | Level |
| Natural | 3 | 10 | 10 | 2 | 5 | 5 |
| person | | | | | | |
| Juridical | 3 | 10 | 10 | 2 | 5 | 5 |
| person | | | | | | |

For example, a dollar amount threshold for a client account associated with a natural person assigned a high risk level and having an average dollar amount of 500,000 NTD and a standard deviation associated with the transactions of 50,000 NTD is calculated by 500,000+(50,000*3)=650,000.

In such a case, when the client account receives three deposit transactions of 1,000,000, 1,200,000 and 3,000,000 NTD in the current business day, the assessment server 5 first determines that since each time the amount of deposit into the client account exceeds the dollar amount threshold (i.e., 650,000 NTD), all three deposit transactions are determined to be abnormal transactions. Then, the assessment server 5 determines that the number of transactions (i.e., 3) exceeds the daily transaction threshold (i.e., 2). As such, all three deposit transactions are determined to be suspicious transactions.

It is noted that the second rule set is created to detect sudden large-amount withdrawal or deposit activities in the client account within the current business day based on the risk factors of the client.

In a third example, the third rule set includes a cash transaction threshold (i.e., a threshold set for the number of cash transactions within the predetermined detecting period), a dollar amount threshold for a client type with a specific risk level (i.e., a threshold set for the dollar amount), and a predetermined withdrawal/deposit ratio range.

With such a rule set, in step 20, when the client account is determined as a dormant account, and when a number of cash transactions involving the client account within the predetermined detecting period is no smaller than the cash transaction threshold, and when an accumulated cash dollar amount within the predetermined detecting period is larger than the dollar amount threshold, and when a withdrawal/deposit ratio of the cash transactions is within the predetermined withdrawal/deposit ratio range, each of the cash transactions occurred during the predetermined detecting period is determined as a suspicious transaction.

Specifically, the client account is determined as a dormant account when the transaction details indicate that the client account is involved in no more than one transaction during a 6-month period that precedes the predetermined detecting period. Moreover, the predetermined detecting period is three business days including the current business day.

The following Table 9 lists exemplary withdrawal/deposit ratio ranges (which are defined by an upper bound and a lower bound), dollar amount thresholds, and daily transaction thresholds set based on attributes of the client.

TABLE 9

| | | | Dollar amount threshold | | | Cash |
|---|---|---|---|---|---|---|
| | Withdrawal/deposit | | (Unit: 10K NTD) | | | transaction |
| | ratio range (%) | | High | Medium | Low | threshold |
| Client | Lower | Upper | Risk | Risk | Risk | (number |
| type | bound | bound | Level | Level | Level | of times) |
| Natural | 90 | 110 | 80 | 80 | 90 | 2 |
| person | | | | | | |
| Juridical | 90 | 110 | 100 | 100 | 100 | 2 |
| person | | | | | | |

A client account associated with a judicial person and determined to be a dormant account may be then monitored for suspicious transactions.

In such a case, when in the predetermined detecting period, the client account receives one cash deposit transaction in the amount of 2,000,000 NTD, and is involved in one cash withdrawal transaction in the amount of 1,900,000 NTD, the assessment server 5 first determines that the accumulated cash dollar amount within the predetermined detecting period (3,900,000 NTD) is larger than the dollar amount threshold (1,000,000 NTD), and the withdrawal/deposit ratio of the cash transactions (95%) is within the predetermined withdrawal/deposit ratio range. Then, the assessment server 5 determines that the number of cash transactions (i.e., 2) is no smaller than the cash transaction threshold (i.e., 2). As such, all two transactions are determined to be suspicious transactions.

It is noted that the third rule set is created to detect suspicious activities in a client account that is considered dormant.

In a fourth example, the fourth rule set includes a deposit amount threshold (i.e., a threshold set for an accumulated deposit amount of all deposit transactions related to the client account within the predetermined detecting period) and a predetermined withdrawal/deposit ratio range.

With such a rule set, in step 20, when the client account is determined as a recently opened account, and when an accumulated deposit amount into the client account during the predetermined detecting period is larger than the deposit amount threshold, and when a withdrawal/deposit ratio of transactions that involve the client account during the predetermined detecting period is within the predetermined withdrawal/deposit ratio range, each of the transactions that occurred is determined as a suspicious transaction.

Specifically, the client account is determined as a recently opened account if the client account was opened within a predetermined period immediately prior to the current business day. In this example, the predetermined period is 90 days. Moreover, the predetermined detecting period is three business days including the current business day. The deposit amount threshold is 900,000 NTD, and the predetermined withdrawal/deposit ratio range is [90%, 110%].

In such a case, when the recently opened account has one cash deposit transaction in the amount of 1,000,000 NTD and one cash withdrawal transaction in the amount of 990,000 NTD in the predetermined detecting period, the assessment server 5 determines that the accumulated deposit amount within the predetermined detecting period (1,000,000 NTD) is larger than the deposit amount threshold (900,000 NTD), and the withdrawal/deposit ratio of the transactions (99%) is within the predetermined withdrawal/deposit ratio range. As such, both cash transactions are determined to be suspicious transactions.

It is noted that the fourth rule set is created to detect suspicious activities in the client account that is considered recently opened.

In a fifth example, the fifth rule set includes a predetermined withdrawal/deposit ratio range.

With such a rule set, in step 20, when a cash withdrawal transaction occurs in one of the client accounts and a cash deposit transaction occurs in another one of the client accounts during the predetermined detecting period, both client accounts belonging to the same client, and when a withdrawal/deposit ratio of a withdrawal amount of the cash withdrawal transaction to a deposit amount of the cash deposit transaction is within the predetermined withdrawal/deposit ratio range, each of the cash withdrawal transaction and the cash deposit transaction is determined as a suspicious transaction. Specifically, the predetermined withdrawal/deposit ratio range may be [85%, 110%].

It is noted that the fifth rule set is created to detect suspicious activities in client accounts that are commonly owned by the client.

In a sixth example, the sixth rule set includes a predetermined deposit/debit ratio.

With such a rule set, in step 20, when the client account is associated with a loan, and when a deposit/debit ratio of an accumulated deposit amount into the client account for paying the loan within the current business day to a debit of the loan is larger than the predetermined deposit/debit ratio, the transaction contributed to the accumulated deposit amount within the current business day is determined as a suspicious transaction. Specifically, the predetermined deposit/payment ratio may be 50%.

When at least one of the transactions is determined as a suspicious transaction in step 20, in step 21, the assessment server 5 may generate an alert, and output the alert to a designated party (e.g., a related party).

It should be noted that the above-mentioned standards of each of the rule sets 42 may be flexibly adjusted and updated by the assessment server 5 according to actual conditions.

In sum, embodiments of the disclosure provide a method that employs the system 100 to assign a risk level to the client based on certain information regarding the client, and to determine whether a transaction involving any client account of the client is a suspicious transaction, based on the risk level and the rule sets 42. The method implemented by the system 100 may be capable of covering a large number of daily transactions during each business day, thereby reducing the possibility of money-laundry related transactions being processed undetected. Additionally, since the rule sets 42 are stored in the rule database 4, they may be readily adjusted to accommodate changes in regulations.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for performing machine detection of a suspicious transaction on at least one client account that is associated with a client, the method being implemented by a system that includes a client database, a rule database, a data management server and an assessment server, the data management server storing data regarding the client account, the method comprising the steps of:
a) retrieving, by the data management server, a data set of client data from the client database, the data set of client data being associated with the client account and the client, and including a number of items respectively directed to a number of risk factors;
b) transmitting, by the data management server, the data set of client data to the assessment server;
c) assigning, by the assessment server, respective risk values to the items of the data set of client data based on a risk-value lookup table that is pre-stored in the rule database;
d) transmitting, by the assessment server, the risk values to the data management server;
e) calculating, by the data management server, a weighted score based on the risk values and a weight list that is pre-stored in the client database and that is associated with the risk factors;
f) assigning, by the data management server, a risk level to the client based on the weighted score;
g) retrieving, by the data management server, from the client database transaction details associated with the client account within a predetermined previous period that is immediately prior to a current business day, the transaction details including information associated with at least one transaction that has occurred on the client account;
h) calculating, by the data management server, a transaction parameter set based on the transaction details;
i) transmitting, by the data management server, the risk level and the transaction parameter set to the assessment server;
j) determining, by the assessment server, whether the client account is involved in at least one transaction during a predetermined detecting period that includes the current business day and at least one previous business day immediately prior to the current business day; and
k) when the determination of step j) is affirmative, determining, by the assessment server, whether the transaction is a suspicious transaction based on the risk level, the transaction parameter set and a rule set pre-stored in the rule database.

2. The method of claim 1, wherein the risk factors are categorized into one or more of:
a client-related category including risk factors of one or more of a client type, a client identification type and a client occupation type;
an account-related category including risk factors of one or more of an account type, a manner in which the client account is opened, a source of fund used to open the client account, a service that is associated with the client account, and an activity frequency of the client account; and
a geographical category including risk factors of one of more of an address of the client and a location in which a financial activity has occurred on the client account.

3. The method of claim 2, the weight list having a number of factor weights corresponding respectively with the risk factors, and three category weights corresponding respectively with the client-related category, the account-related category and the geographical category, wherein step e) includes:
in response to the risk values, weighting the risk values respectively with the factor weights to obtain a number of factor-weighted values, respectively;
calculating three category summations each by summing the factor-weighted values categorized in a respective one of the client-related category, the account-related category and the geographical category;
weighting the three category summations respectively with the three category weights to obtain three weighted components, respectively; and
adding the three weighted components to obtain the weighted score.

4. The method of claim 1, wherein step f) includes: assigning a high risk level to the client when the weighted score is above a first threshold;
assigning a medium risk level to the client when the weighted score is between the first threshold and a second threshold that is smaller than the first threshold; and
assigning a low risk level to the client when the weighted score is below the second threshold.

5. The method of claim 1, wherein the rule set includes a daily transaction threshold, and a daily dollar amount threshold for a client type and the risk level of the client,
wherein, in step k), when a number of transactions involving the client account within the current business day is no smaller than the daily transaction threshold, and when at least one of a total cash withdrawal amount from the client account and a total cash deposit amount into the client account within the current business day exceeds the daily dollar amount threshold, at least one of the transactions that contributes to the at least one of the total cash withdrawal amount and the total cash deposit amount is determined as a suspicious transaction.

6. The method of claim 1, wherein the transaction parameter set includes an average dollar amount of multiple transactions within the predetermined previous period, and a standard deviation associated with the dollar amounts of the transactions within the predetermined previous period.

7. The method of claim 6, wherein the rule set includes a daily transaction threshold and a dollar amount threshold for the client type and the risk level of the client,
wherein, in step k), when a number of abnormal transactions each involving an amount larger than the dollar amount threshold is no smaller than the daily transaction threshold, the abnormal transactions are determined as suspicious transactions.

8. The method of claim 7, wherein the dollar amount threshold is calculated by
T_{d}=Avg+(Stdev*M),
where T_{d} represents the dollar amount threshold, Avg represents the average dollar amount, Stdev represents the standard deviation, and M represents a multiplier associated with the risk level of the client.

9. The method of claim 1, wherein the rule set includes a cash transaction threshold, a dollar amount threshold for a client type with a specific risk level, and a predetermined withdrawal/deposit ratio range,
wherein, in step k), when the client account is determined as a dormant account, and when a number of cash transactions that involve the client account is no smaller than the cash transaction threshold within the predetermined detecting period, when an accumulated cash dollar amount of the cash transactions involving the client account within the predetermined detecting period is larger than the dollar amount threshold, and when a withdrawal/deposit ratio of the cash transactions is within the predetermined withdrawal/deposit ratio range, each of the cash transactions that occurred during the predetermined detecting period is determined as a suspicious transaction.

10. The method claim 9, wherein the client account is determined as a dormant account when the transaction details indicate that the client account in involved in no more than one transaction during a 6-month period that precedes the predetermined detecting period.

11. The method of claim 1, wherein the rule set includes a deposit amount threshold and a predetermined withdrawal/deposit ratio range,
wherein, in step k), when the client account is a recently opened account, and when an accumulated deposit amount into the client account during the predetermined detecting period is larger than the deposit amount threshold, and when a withdrawal/deposit ratio of transactions that involve the client account during the predetermined detecting period is within the predetermined withdrawal/deposit ratio range, each of the transactions that occurred is determined as a suspicious transaction.

12. The method of claim 11, wherein the client account is determined as a recently opened account when the client account was opened within a predetermined period immediately prior to the current business day.

13. The method of claim 1, wherein the rule set includes a predetermined withdrawal/deposit ratio range,
wherein, in step k), when the client owns an additional account, and when a cash withdrawal transaction occurs in one of the client account and the additional account and a cash deposit transaction occurs in the other one of the client account and the additional account during the predetermined detecting period, and when a withdrawal/deposit ratio of a withdrawal amount of the cash withdrawal transaction to a deposit amount of the cash deposit transaction is within the predetermined withdrawal/deposit ratio range, each of the cash withdrawal transaction and the cash deposit transaction is determined as a suspicious transaction.

14. The method of claim 1, wherein the rule set includes a predetermined deposit/payment ratio,
wherein, in step k), when the client account is associated with a loan, and when a deposit/debit ratio of an accumulated deposit amount into the client account for paying the loan within the current business day to a debit of the loan is larger than the predetermined deposit/debit ratio, at least one transaction contributing to the accumulated deposit amount within the current business day is determined as a suspicious transaction.
